(19) United States
(12) Patent Application Publication
(10) Pub. No.: US 2002/0196788 A1
(43) Pub. Date: Dec. 26, 2002

(54) System and method for using the address of internet protocol version 6

(76) Inventor: Kwangwoo An, Federal Way, WA (US)

Correspondence Address: Kwangwoo An, 2205 S 312th St #C-18, Federal Way, WA, 98003, US

(21) Appl. No.: 10/104,004

(22) Filed: Mar. 25, 2002

(30) Foreign Application Priority Data
Jun. 5, 2001 (KR) 10-2001-0031377

(51) Int. Cl. H04L 12/28

(52) U.S. Cl. 370/395.52

(57) ABSTRACT

This invention describes a method for transitioning IPV4 to IPV6, IPV6's packet definition, and domain name style. This information provides explanations of the IPV6's address packet definition. The method used is an efficient way to control all electric goods in a network with one IP address (telephone number). This type of packet definition will reduce hop count, which dramatically improves speed, reliability, connections, and overall performance.

### BACKGROUND OF THE INVENTION

Brainstormed ideas and ways to construct an easier and more efficient network of systems. Having the knowledge that sometime soon all IPV4 will convert to IPV6, finding the best way to make the conversion.

### BRIEF SUMMARY OF THE INVENTION

Using phone numbers as IP addresses for easy usage and expanding the domain name for the user's desires. Finding the easiest way to communicate between the two versions (IPV4 and IPV6).

### BRIEF DESCRIPTION OF THE SEVERAL VIEWS OF THE DRAWINGS

### DETAILED DESCRIPTION OF THE INVENTION

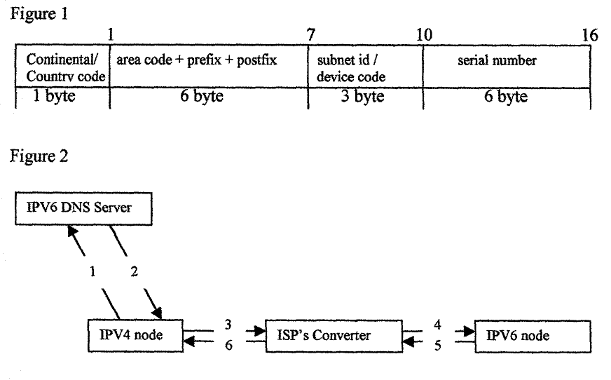

FIG. 1 is definition of IPV6's address packet. I divided this first byte into 2 bit and 6 bit fields. First the 2-bit field represents the continental code and last 6-bit field represents each country in the continents. I assigned 0 for America, 1 for Asia (include New Zealand and Australia), 2 for Europe, and 3 for Africa. This number can be changed under worldwide conditions. Each country code can be assigned in alphabetical order, using country names, under their continental code. The next six bytes consists of everyday telephone numbers used to call one another. For example, your area code plus the regular phone number, which will be contained in the six bytes. The next 3-byte field will be used for subnet id and device code id. If subnet id field use 2 byte then 1 byte is for device code field. If subnet id field use 1 byte then 2 byte is for device code field (the three bytes can be used interchangeably). The device code id is to manage every electric goods easily in the house: small, medium, or large size companies. For example, in large networking, there are many routers and I set the device code 1 for the router. Then it's easy to manage router one at a time. If there are same robots or TV sets in large factory or within network. This device code makes diagnostics, sending and receiving the same signal simple. This field's device code works likes port number in TCP packet. I mean globally, popular electric goods can be assigned the same number all over the world, such as web service port that is assigned with 80. TV set can be assigned as 1, cellular phone can be assigned as 2, telephone can be assigned as 3, etc . . . The 6-byte field is known as the interface id. But there's another problem with this interface id which assigned is exhausted rapidly because 2 byte fields are already assigned to companies. So the usage of serial number of electrical goods id is to identify easier by manufacturing companies. And when manufacturing companies need to access their own electric goods for diagnostic purpose, it can be used the product id which tells every possible information about the product.

I also changed the new Domain name style to be different with the currently used domain name (i.e.: com, edu, org, net, etc . . . ). When we take a glance at domain names it doesn't tell much information. My new naming style is convenient to research many different items and companies. Still it is hard to advertise their own domain names to the small and mid size-companies because the cost of advertising is so great. It's not made for individuals, small business, or mid size business. My idea for a new domain name style is using job category and name. For example, If there is a flower shop named “pretty”, then it's domain name would be “flower.pretty” or “pretty.flower.” and if there is a real estate company named Millennium Real Estate then it's domain name would be “Millennium.realestate” or “realestate.Millennium.” You would be able to create your own domain name category. For example, if you were to own a liquor store and you wanted to choose a domain to advertise on the internet, you can create any category you want with your business name (i.e. “bobsliqor.alchohol”, “bobsliquor.drinks”, “bobsliquor.baccus”, “bobsliquor.dionysia”, or “bobsliquor.bottomsup”). FIG. 2 is to deploy a transition from IPV4 to IPV6. So, the domain name server should be changed from my idea. The currently used domain name server is maintained by mapping the IPV4 address and the current domain name. By my idea, my domain name server is maintained by mapping the IPV4 address, IPV6 address, and the domain name. From FIG. 2 the steps will represent the operation that will be done. In step1—it will query the IPV6's domain name, step2—resolve and send back the IPV4 address of mapped address with IPV6 domain name, step3—send data packet addressed with received IPV4 address, step4—convert to IPV6 address, step5—convert to IPV4 address, step6—send back data packet to the originator.

1) What I claim as my invention is using a telephone number as part of a IVP6 address packet.

2) What I claim as my invention is using the device code to control electric goods.

3) What I claim as my invention is using electric goods' serial numbers as part of IPV6's address packet.

4) What I claim as my invention is letting the user create their own domain name category.

5) What I claim as my invention is mapping the IPV4 address, IPV6 address and domain name.
